(19) United States
(12) Patent Application Publication
(10) Pub. No.: US 2003/0191712 A1
(43) Pub. Date: Oct. 9, 2003

(54) Electronic money issuing system

(76) Inventor: Kenichi Ohmae, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/333,800

(22) PCT Filed: Jul. 16, 2001
(86) PCT No.: PCT/JP01/06129

(30) Foreign Application Priority Data
Jul. 24, 2000 (JP) 2000-222826

(51) Int. Cl. G06F 17/60

(52) U.S. Cl. 705/41; 705/39

(57) ABSTRACT

An electronic money issuing system of low risk. A float center server (200) manages information on electronic money issued to a user and information on the capital (e.g. bank deposit and real estate) of the user and on credit limit backing the issuance of electronic money. Electronic money is issued for payment. When the receiver transmits the amount and

### TECHNICAL FIELD

The present invention relates to a method for issuing electronic money, electronic money, an electronic money issuing server, a user terminal and an electronic money issuing system, and, more particularly, to electronic money which is electronically circulated like bills and coins, and a method for issuing electronic money, an electronic money issuing server, a user terminal and an electronic money issuing system for the electronic money.

### BACKGROUND ART

In payment for commercial transactions in markets, checks, promissory notes, credit cards and debit cards are conventionally used in addition to physical currency such as bills and coins.

The conventional methods have the following problems. Bills and coins are inconvenient to carry especially when the amount is large. As for checks or promissory notes, it is difficult to have a checkbook or a promissory note book issued by a bank and it takes time and effort to manage from the standpoint of issuers, and it takes days to recover the credit from the standpoint of receivers. Promissory notes carry a large risk of chain-reaction bankruptcies due to a bounce. Credit cards require high commission and takes time to be cleared. As for debit cards, the payment amount is immediately debited from a payer's bank account, but it takes days before the receiver recovers the payment.

It is, therefore, an object of the present invention to provide electronic money as currency which is convenient to carry and easy to manage and which carries only a small risk, a method for issuing such electronic money, and an electronic money issuing server, a user terminal and an electronic money issuing system for such electronic money.

### DISCLOSURE OF INVENTION

In accomplishing the above object, a method for issuing electronic money according to the present invention comprises, as shown for example in FIG. 11, a step 1114 of inputting issuer identification information for identifying an issuer with a user terminal; a step 1104 of inputting an amount of electronic money to be issued with the user terminal; a step 1104 of inputting a specific settlement date with the user terminal; and a step 1114 of linking the issuer identification information with one or more substantial proofs belonging to the issuer to allow a reservation based upon the amount of electronic money to be issued to be made for the one of more substantial proofs.

The user terminal is typically a computer such as a personal computer or a cellular phone.

Since the method for issuing electronic money constituted as above includes the step 1114 of linking the issuer identification information with one or more substantial proofs belonging to the issuer to allow a reservation based upon the amount of electronic money to be issued to be made for the one of more substantial proofs, guaranteed electronic money can be issued.

Another method for issuing electronic money according to the present invention comprises, as shown for example in FIG. 11, a step 1115 of receiving issuer identification information for identifying an issuer inputted with a user terminal therefrom; a step 1105 of receiving an amount of electronic money to be issued inputted with the user terminal therefrom; a step 1105 of receiving a specific settlement date inputted with the user terminal therefrom; and a step 1122 of linking the received issuer identification information with one or more substantial proofs belonging to the issuer to make a reservation based upon the received amount of electronic money to be issued for the one of more substantial proofs.

The linking is typically performed in real time.

Since the method for issuing electronic money constituted as above includes the step 1122 of linking the issuer identification information with one or more substantial proofs belonging to the issuer to make a reservation based upon the amount of electronic money to be issued for the one of more substantial proofs, guaranteed electronic money can be issued.

The method for issuing electronic money may further comprise a step of receiving values of one or more proofs belonging to an issuer from a proof managing server 300 (FIG. 6) for managing the proofs associating the proofs with the issuer; a step of storing original values of the proofs which are real values of the proofs or substantial values of the proofs which are calculated by multiplying a specified reduction rate by the original values of the proofs in a proof value file 210 (FIG. 5); a step of linking the values of the proofs stored in the proof value file 210 with the proofs managed by the proof managing server 300; and a step of making a reservation for the proofs within a total substantial proof value which is a sum of the substantial values of the proofs stored in the proof value file 210 and designating a specific settlement date to issue electronic money which is valid until the settlement date.

Since the method for issuing electronic money constituted as above includes the step of storing original or substantial values of the proofs in a proof value file 210, a reservation can be made without accessing the proof managing server every time necessary. The linking may be performed, in real time, every time the values of the proofs change or performed at a time in bulk when the issuer makes an access to the electronic money issuing server 200 (FIG. 5). To associate the issuer and the values of proofs, a user number and the account numbers of the proofs can be used.

In the above methods for issuing electronic money, in making a reservation for the proofs, a proof with lower liquidity is preferably reserved first.

Constituted as above, a proof with lower liquidity can be reserved first among the proofs. For example, a fixed deposit, which has a lower liquidity than a saving account deposit, can be reserved first.

In the above methods for issuing electronic money, the amount of electronic money to be issued is preferably a total of a price of an object of transaction and interest on the price for days from the date of issue of the electronic money to the specific settlement date.

In accomplishing the above object, electronic money according to the present invention is issued by any one of the above methods for issuing electronic money.

Electronic money is fictitious currency of the amount stored in a file in a computer, and electronically exchanged between a payer and a receiver as in the case with real currency.

In accomplishing the above object, an electronic money issuing server 200 according to the present invention comprises, as shown for example in FIG. 5, an issuer identification information file 209 for storing issuer identification information for identifying an issuer inputted with an user terminal; an issue amount file 211 for storing an amount of electronic money to be issued, inputted with the user terminal; a settlement date file 211 for storing a specific settlement date inputted with the user terminal; and a control section 201 for linking the issuer identification information and one or more substantial proofs belonging to the issuer to make a reservation based upon the inputted amount of electronic money to be issued for the substantial proofs.

The information, the amount of electronic money to be issued, and the settlement date inputted with a user terminal are transmitted therefrom. The electronic money issuing server 200 is provided with a communication interface 205 for receiving the transmitted information and so on.

The electronic money issuing server 200 is one for practicing the method for issuing electronic money of the present invention, for example.

In accomplishing the above object, a user terminal 100 according to the present invention comprises, as shown for example in FIG. 4, an issuer identifying means 113 for identifying an issuer and generating issuer identification information; an issue amount input means 112 for inputting an amount of electronic money to be issued; a settlement date input means 112 for inputting a specific settlement date of the electronic money; and a transmission means 116 for transmitting the issuer identification information, the amount of electronic money to be issued and the specific settlement date to an electronic money issuing server for making a reservation based upon the amount of electronic money to be issued for substantial proofs while linking the issuer identification information, the amount of electronic money to be issued and the specific settlement date with one or more substantial proofs belonging to the issuer.

The issue amount input means 112 and the settlement date input means may be one device (such as a keyboard or a voice input device).

The identification information recognized by the issuer identifying means is used as issuer identification information for identifying the issuer. The issuer identifying means 113 is a biological information recognition system for recognizing biological information peculiar to an individual such as a fingerprint recognition system.

The user terminal 100 is a user terminal for practicing the method for issuing electronic money of the present invention, for example, and typically configured to serve as both an electronic money issuing terminal and an electronic money receiving terminal. The user terminal 100 may be a conventional cellular phone or personal computer connectable to the Internet to which an issuer identifying means is attached.

In accomplishing the above object, the electronic money issuing server 200 according to the present invention comprises, as shown for example in FIG. 5, a receiving means 205 for receiving values of one or more proofs belonging to an issuer from a proof managing server 300 for managing the proofs by associating the proof with the issuer; a proof value file 210 for storing original values of the proofs which are real values of the proofs or substantial values of the proofs which are calculated by multiplying a specific reduction rate by the original values of the proofs; and a link control section 201 for linking the values of the proofs stored in the proof value file 210 with the proofs managed by the proof managing server 300; the electronic money issuing server 200 being adapted to make a reservation for the proofs within a total substantial proof value which is a sum of the substantial values of the proofs stored in the proof value file 210 and designating a specific settlement date to issue electronic money which is valid until the settlement date.

Also in accomplishing the above object, an electronic money issuing system according to the present invention comprises, as shown for example in FIG. 1, a host computer 200 for managing electronic money; a branch computer 300/1, 300/2 and/or 300/3 connected or connectable to the host computer 200; and a user terminal 100/1, 100/2, 100/3 and/or 100/4 connected or connectable to the host computer 200 and used to input issuer identification information and an amount of electronic money to be issued by an issuer when the issuer issues electronic money; and the branch computer 300/1, 300/2 and/or 300/3 having a proof value file 315 (FIG. 6) for storing substantial values of one or more substantial proofs belonging to the issuer of electronic money; the host computer 200 being configured to link the issuer identification information with the proof value file 315 in the branch computer 300/1, 300/2 and/or 300/3; the host computer 200 being adapted to issue electronic money which is valid until a specific settlement day designated based on an input with the user terminal 100/1, 100/2, 100/3 and/or 100/4 within a total proof value which is a sum of the substantial values of the proofs, and to make a reservation for the proofs in an amount corresponding to the amount of electronic money to be issued inputted with the user terminal 100/1, 100/2, 100/3 and/or 100/4 when the electronic money is issued.

The host computer 200 typically has an electronic money scheduled issue amount file 210 (FIG. 5) for storing the issuer identification information and a scheduled issue amount of electronic money associated with the issuer identification information, and the scheduled issue amount of electronic money in the electronic money scheduled issue amount file 210 is adapted to link with, the substantial values of proofs in the proof value file 315.

The electronic money may be issued as being valid until a designated specific settlement date within the scheduled issue amount of electronic money in the electronic money scheduled issue amount file 210.

In accomplishing the above object, an electronic money issuing server 200 according to the present invention is connected or connectable to a branch computer 300 having a proof value file 315 for storing substantial values of one or more substantial proofs belonging to an issuer of electronic money; connected or connectable to a user terminal 100 used to input issuer identification information and an amount of electronic money to be issued by an issuer when the issuer issues electronic money; adapted to link the issuer identification information transmitted from the user terminal with the proof value file 315 in the branch computer 300; and adapted to issue electronic money which is valid until a specific settlement date designated based on an input with the user terminal 100 within a total-proof value which is a sum of the substantial values of the proofs, and to make a reservation for the proofs in an amount corresponding to the amount of electronic money to be issued inputted with the user terminal when the electronic money is issued.

The branch computer 300 is typically a computer used in a financial institution (such as a bank).

In accomplishing the above object, the electronic money issuing server 200 according to the present invention is connected or connectable to a branch computer 300 having a proof value file 315 for storing substantial values of one or more substantial proofs belonging to an issuer of electronic money; connected or connectable to a user terminal 100 used to input issuer identification information and an amount of electronic money to be issued by an issuer when the issuer issues electronic money; has an electronic money scheduled issue amount file 210 for storing the issuer identification information and a scheduled issue amount of electronic money associated with the issuer identification information; the scheduled issue amount of electronic money in the electronic money scheduled issue amount file 210 being linked with the substantial values of the proofs in the proof value file 315 in the branch computer 300; the electronic money being issued with a specific settlement date designated based on an input with the user terminal 100 within the scheduled issue amount of electronic money in the electronic money scheduled issue amount file 210 as being valid until the settlement date; and configured to make a reservation for the proofs in an amount corresponding to the amount of electronic money to be issued inputted with the user terminal when the electronic money is issued.

The user terminal 100 according to the present invention is connected or connectable to the electronic money issuing server 200; and configured to be used to input issuer identification information for identifying the issuer and an amount of electronic money to be issued when the issuer issues the electronic money.

The user terminal 100 of the present invention may further comprises a biological information input means 113 (FIG. 4) for inputting biological information peculiar to an individual; and be configured to use the biological information as the issuer identification information.

This application is in the bases of Japanese Patent Application No. 2000-222826, which is incorporated in this application and forms a part thereof

The invention can be fully understood, referring to the following description in details. Further extensive applications of the invention will be apparent from the following description in details. However, it should be noted that the detailed description and specific examples are preferred embodiments of the invention, only for the purpose of the description thereof. Because it is apparent for the person ordinary skilled in the art to modify and change in variety of manners, within the scope and spirits of the invention. The applicant does not intend to dedicate any disclosed embodiments to the public, and to the extent any disclosed modifications or alternations may not literally fall within the scope of the claims, they are considered to be part of the invention under the doctrine of the equivalents.

### BRIEF DESCRIPTION OF DRAWINGS

FIG. 1 is a conceptual view, illustrating the outline of a float system as an embodiment of the present invention;

FIG. 2 is a block diagram, illustrating examples of user terminals used by users in the embodiment of the present invention;

FIG. 3 is a block diagram, illustrating examples of branch computers used in the embodiment of the present invention;

FIG. 4 is a block diagram, illustrating an example of the constitution of the user terminal used by a user in the embodiment of the present invention;

FIG. 5 is a block diagram, illustrating an example of the constitution of a server used in the embodiment of the present invention;

FIG. 6 is a block diagram, illustrating an example of the constitution of a branch computer used in the embodiment of the present invention;

FIG. 7 is a flowchart, illustrating an outline of the procedure of using electronic money used in the embodiment of the present invention;

FIG. 8 is a flowchart, illustrating an example of the process at the time when a user uses the float system for the first time;

FIG. 9 is a flowchart, illustrating an example of the process at the time when a user makes a registration for an account necessary to issue float system electronic money in the embodiment of the present invention;

FIG. 10 is a flowchart, illustrating an example of the process at the time when a user makes a registration for an account designated by a credit limit in the embodiment of the present invention;

FIG. 11 is a flowchart, illustrating an example of the process at the time when a user makes a reservation for electronic money necessary to make a payment of electronic money in the embodiment of the present invention;

FIG. 12 is a flowchart, illustrating an example of the process at the time when a user makes a payment of electronic money after a suspension;

FIG. 13 is a block diagram, illustrating an example of entry items on electronic money used by a user in the embodiment of the present invention;

FIG. 14 is a flowchart, showing an example of the process of settling electronic money in the embodiment of the present invention;

FIG. 15 is a conceptual view, illustrating transactions of electronic money in Transaction Example 1 in the embodiment of the present invention.

FIG. 16 is a conceptual view, illustrating transactions of electronic money in Transaction Example 2 in the embodiment of the present invention.

FIG. 17 is a conceptual view, illustrating transactions of electronic money in Transaction Example 3 in the embodiment of the present invention.

FIG. 18 is a conceptual view, illustrating transactions of electronic money in Transaction Example 4 in the embodiment of the present invention.

### PREFERRED EMBODIMENTS OF THE INVENTION

Description will be hereinafter made of the embodiments of the present invention with reference to the drawings. The same or corresponding members are designated in the drawings by the same numerals and the description may not be repeated.

An electronic money issuing system according to the embodiments of the present invention may be hereinafter referred to as “float system.” An organization which manages the float system may be hereinafter referred to as “float center,” and an electronic money issuing server used in the float center may be hereinafter referred to as “float center server.” The float center server is typically installed in the float center.

Description will be made of the float system according to an embodiment of the present invention.

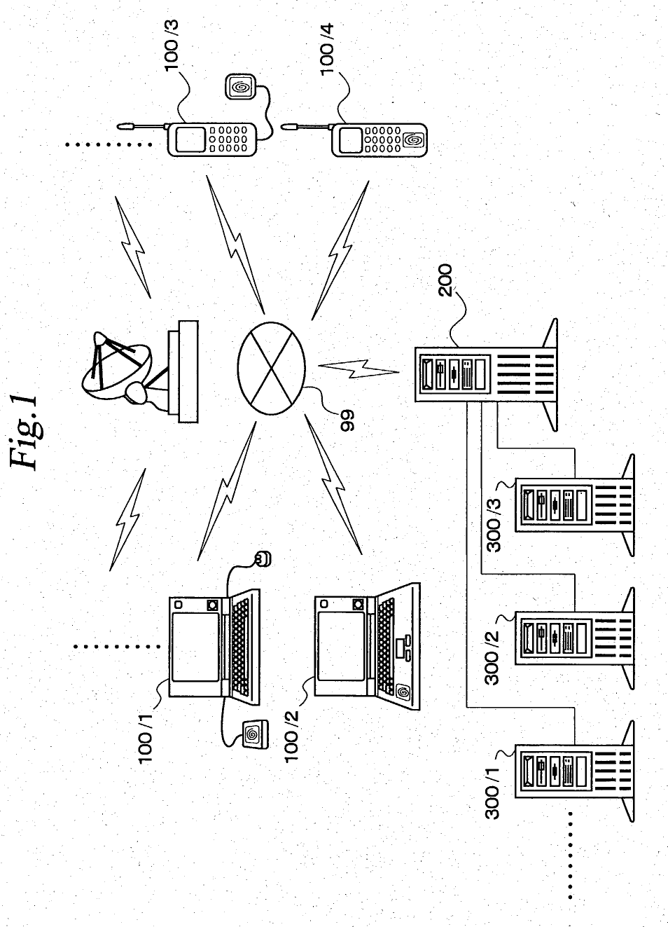

FIG. 1 is a conceptual view of the float system according to an embodiment of the present invention. Each of users (issuers or receivers) having an intention of conducting commercial transactions using electronic money operates its own terminal among user terminals 100/1, 100/2, 100/3 and 100/4. Hereinafter, when there is no need to distinguish each of the user terminals, the term “user terminal(s) 100” will be used. A user terminal 100 is typically a computer such as a personal computer but may be a Web TV, an information home appliance in which an IC (integrated circuit, including also a large-scale integration) is incorporated or a cellular phone in which an IC is incorporated.

The user terminals 100 are connected to a float center server 200 as an electronic money issuing server through a network 99. The float center server 200 is connected by exclusive lines to a plurality of branch computers 300/1, 300/2 and 300/3 in which values of proofs of electronic money are stored. Hereinafter, when there is no need to distinguish each of the branch computers, the term “branch computer(s) 300; ” may be used.

A user connects a user terminal 100 with the float center server 200 which is installed outside as seen from the user terminal 100, through the network 99 to issue or receive electronic money. The number of the user terminals 100 is the same as that of the users, namely plural. The network (which may be hereinafter simply referred to as “net”) 99 can be in the form of radio waves of TV, a satellite Internet, cable lines, or inter-waves of TV as well as a computer network such as the Internet or telephone lines. The float center server 200 can be in the form of various types of computers such as a personal computer, a workstation and a mainframe.

Each of the user terminals 100 may be connected to the float center server 200 directly through a line constituting the network 99 or via a one or plurality of providers on the network.

Each of the branch computers 300 is connected to the float center server 200 by an exclusive line. The float center server 200 and the branch computers 300 may be connected to each other by the net 99.

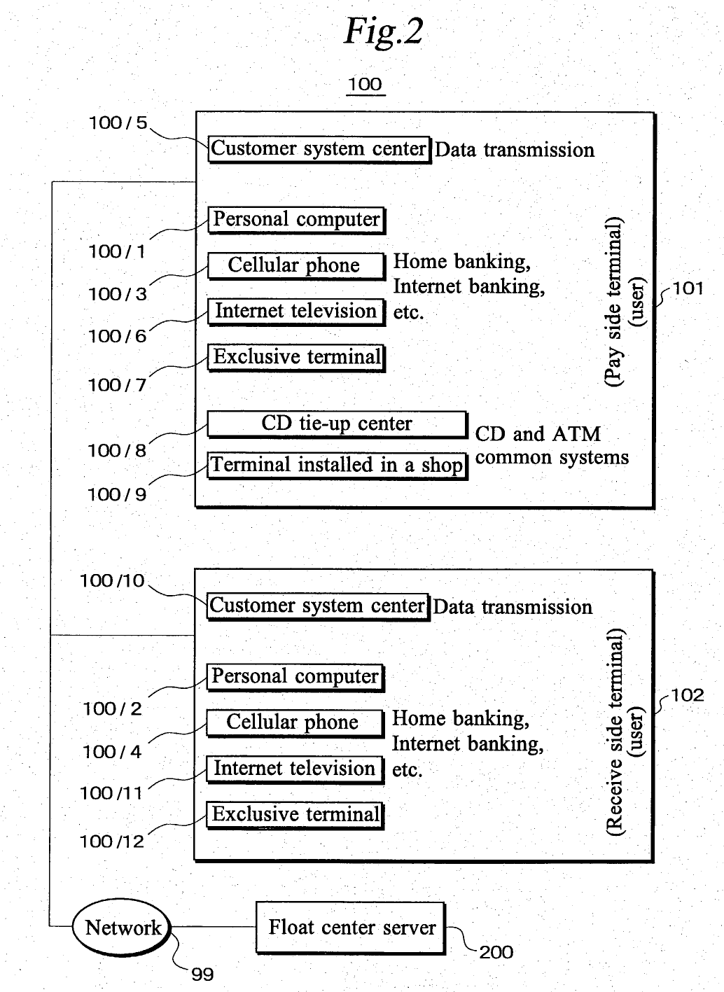

FIG. 2 is a block diagram illustrating examples of the user terminals 100. The user terminals 100 are classified into payer terminals 101 as pay side user terminals and receiver terminals 102 as receipt side user terminals. The payer terminals 101 include cellular phones 100/3 and personal computers 100/1 used for home banking, Internet banking, etc., internet televisions 100/6 and customer system centers 100/5 used in data transmission, etc., exclusive terminals 100/7, and terminals 100/9 installed in shops and CD tie-up centers 100/8 as CD and ATM common system centers.

The receiver terminals 102 include cellular phones 100/4 and personal computers 100/2 used for home banking, Internet banking, etc., internet televisions 100/11, exclusive terminals 100/12 and customer system centers 100/10 used in data transmission, etc.

Although the user terminals 100 are classified into the payer terminals 101 and the receiver terminals 102, there may be terminals which serve as a payer terminal 101 at one time and a receiver terminal 102 at another. A payer terminal 101 may has a function of a receiver terminal 102 so that a payer and a receiver can alternately operate a payer terminal 101 or a receiver terminal 102 to send and receive electronic money.

The personal computers 101/1 and 100/2 exist not only in offices but also at homes and thus enable electronic money to be used at homes with Internet functions thereof. Some of the personal computers 101/1 and 100/2 are portable and thus enable electronic money to be used at other places.

Cellular phones have been rapidly spread because of their convenience, and some of them have Internet functions in addition to the conventional communication function (i-mode cellular phones (trademark), for example). The cellular phones 100/3 and 100/4 enable electronic money to be used at any time and any place due to their high portability.

Each of the customer system centers 100/5 and 100/10 comprises a large-scale personal computer or an office computer, for example, and can totally manage electronic money paid or received by a plurality of personal computers 100/1 and 100/2 and cellular phones 100/3 and 100/4 via the customer system center 100/5 and 100/10. Thereby, for example, a company can manage accounts of the electric money used by the staff, as a whole, at one of the customer system centers 100/5 and 100/10.

The internet televisions 100/6 and 100/11, which have ICs installed therein and thus can serve as personal computers, enable electronic money to be easily used at homes. The exclusive terminals 100/7 and 100/12, which are computers provided for issuing and/or receiving only, are easy to operate as compared with the general-purpose personal computers 100/1 and 100/2 and the general-purpose cellular phones 100/3 and 100/4 which are versatile devices, and thus enable electronic money to be used more easily.

Also, users can pay electronic money using terminals 100/9 installed in shops at the CD tie-up centers 100/8 which they use for cash withdrawal and so on, and thus can use electronic money more easily and conveniently.

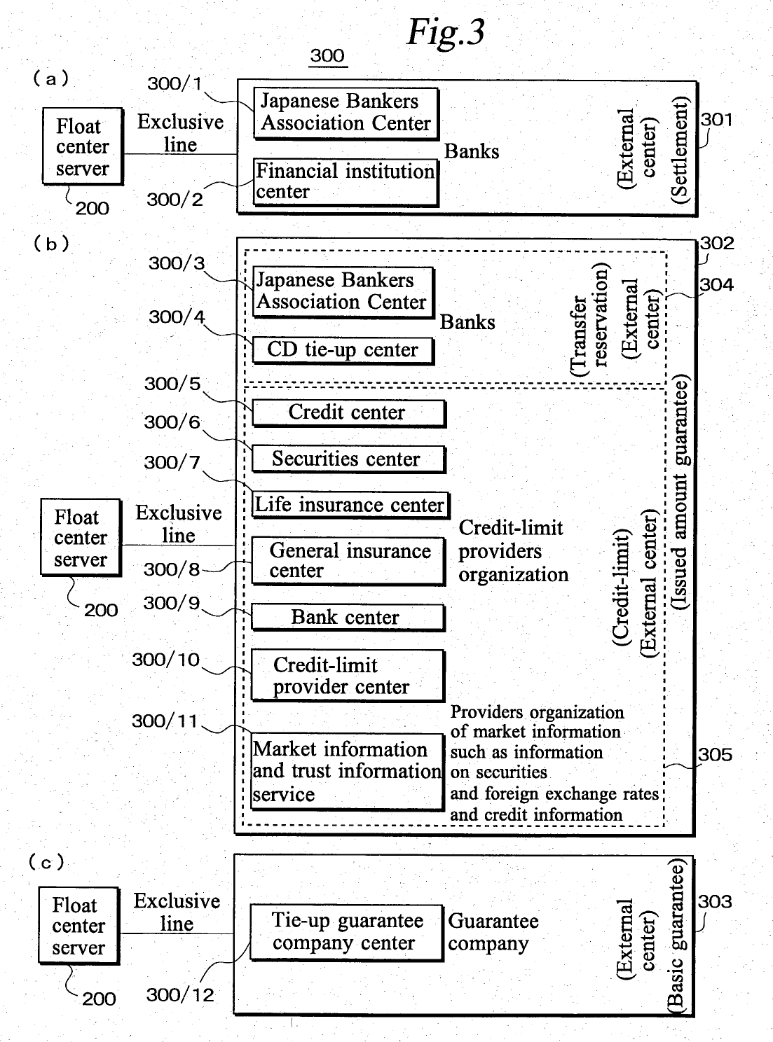

FIG. 3 is a block diagram illustrating examples of the branch computers 300 as external centers. The branch computers 300 as external centers can be classified into settlement branch computers 301 for conducting settlements of issued amounts, issued amount guarantee branch computers 302 for guaranteeing the issued amounts, and basic guarantee branch computers 303 for giving basic guarantees for issued amounts.

As shown in FIG. 3(a), the settlement branch computers 301 include the Japanese Bankers Association center computer 300/1 of Data Telecommunication System of All Banks, which is a network system among banks, and financial institution center computers 300/2 in financial institution centers, which are settlement systems of credit-limit providers. Thereby, a settlement can be made when setting a credit-limit as well as by deposit money in a bank. In the settlement branch computers 301, settlements are made by real currency (not electronic money).

As shown in FIG. 3(b), the issued amount guarantee branch computers 302 are classified into transfer reservation branch computers 304 for making transfer reservations and credit branch computers 305 for setting credit-limits. The transfer reservation branch computers 304 include the Japanese Bankers Association center computer 300/3 and CD tie-up center computers 300/4 as CD and ATM common system centers of banks and non-bank financial institutions. Thereby, a user can make a transfer reservation at the nearest terminal such as an ATM, without going all the way to its bank or an ATM of the bank.

The credit branch computers 305 of credit-limit providers include credit center computers 300/5, securities center computers 300/6, life insurance center computers 300/7, general (non-life) insurance center computers 300/8, bank center computers 300/9, credit-limit provider center computers 300/10, market information and credit information service computers 300/11 of providers of market information such as information on securities and foreign exchange rates and credit information.

Thereby, a user can make a transfer reservation by setting a credit-limit or by using its credit or its own securities, insurance, real estates or the like as well as with its bank deposit as a proof The credit-limit of a user is determined based on market information and credit information, and a transfer reservation of an amount only within the credit-limit, namely an amount calculated by multiplying the credit-limit by a predetermined reduction rate, can be made so that the transfer reservation can be made credible.

The above computers stores proofs for issuing electronic money, and are connected to the float center server 200 to accept a reservation thereof in issuing electronic money.

As shown in FIG. 3(c), the basic guarantee branch computers 303 include tie-up guarantee company center computers 300/12 of guarantee companies. Basic guarantee is a system under which a guarantee company guarantees the issued amount of electronic money and settles the issued amount when a settlement default occurs.

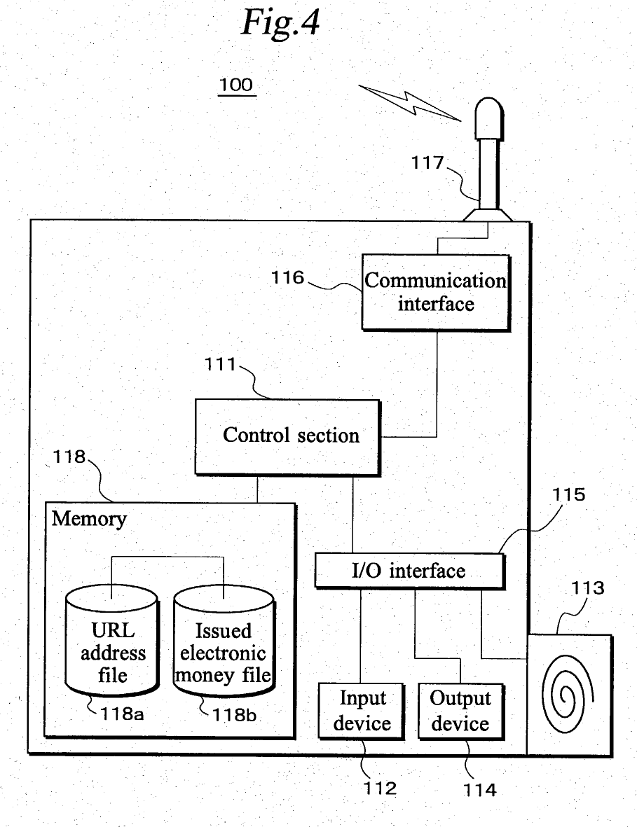

FIG. 4 is a block diagram illustrating an example of the constitution of the user terminal 100 which a user operates to use electronic money.

In using electronic money, namely in issuing or receiving electronic money, a user provides instructions to the user terminal 100 or inputs information to use electronic money thereinto with an input device 112 comprised in the user terminal 100. The input device 112 is typically a keyboard, but may be a mouse, a microphone (in the case of a voice input system), a remote controller, a touch screen or the like.

The user terminal 100 is provided with a fingerprint recognition system 113 for identifying an electronic money issuer (which may be hereinafter referred to as “issuer”) as a user and the user inputs issuer identification information into the user terminal 100. The means for identifying the issuer, which is a fingerprint recognition system 113 in this embodiment, may be another biological information recognition system for recognizing biological information peculiar to each individual such as an iris recognition system, a voice print recognition system or a palm print recognition system, or a password input system.

To display the inputted amount of issued electronic money and so on, an output device 114 comprised in the user terminal 100 is used. The output device 114 is, for example, a display such as a CRT or a liquid crystal display, or a printer. The input device 112 and the output device 114, which are illustrated in FIG. 4 as being integrated with the user terminal 100, may be separated therefrom. The user terminal 100 has an I/O interface 115 for controlling the input device 112, the output device 114 and the fingerprint recognition system 113. In the user terminal 100, the input device 112 and the output device 114 are connected to a control section 111 through the I/O interface 115.

The control section 111 is connected to a communication interface 116 for transmitting information (for example data) to the float center server 200 and receiving information from the float center server 200. In such a way described above, information on issued electronic money in transmitted and received.

A memory 118 is connected to the control section 111. A URL address file 118a and an issued electronic money file 118b are included in the memory 118. In the URL address file 118a are stored the URL address of the float center server 200, URL addresses for use in home banking and so on. In connecting to the float center server 200, a user calls the URL address thereof from the URL address file. Thus, the user does not have to input the URL address every time connection is to be made or memorize the URL address.

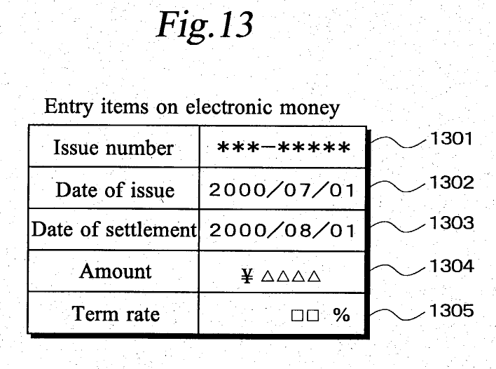

In the issued electronic money file 118b, entry items on electronic money which has been issued, such as the issue number, date of issue, issued amount, settlement date, and term rate as shown in FIG. 13 can be recorded. Thus, the user can check the information on the issued electronic money at any time and utilize it in management of the issued amount and the settlement date thereof.

When the user issued electronic money using another user terminal 100, the issued electronic money file 118b can be updated by receiving information on the issued electronic money from the float center server 200. Thus, the user can manage electronic money issued with the other user terminals 100. The component files stored in the memory 118 are not limited to the above files.

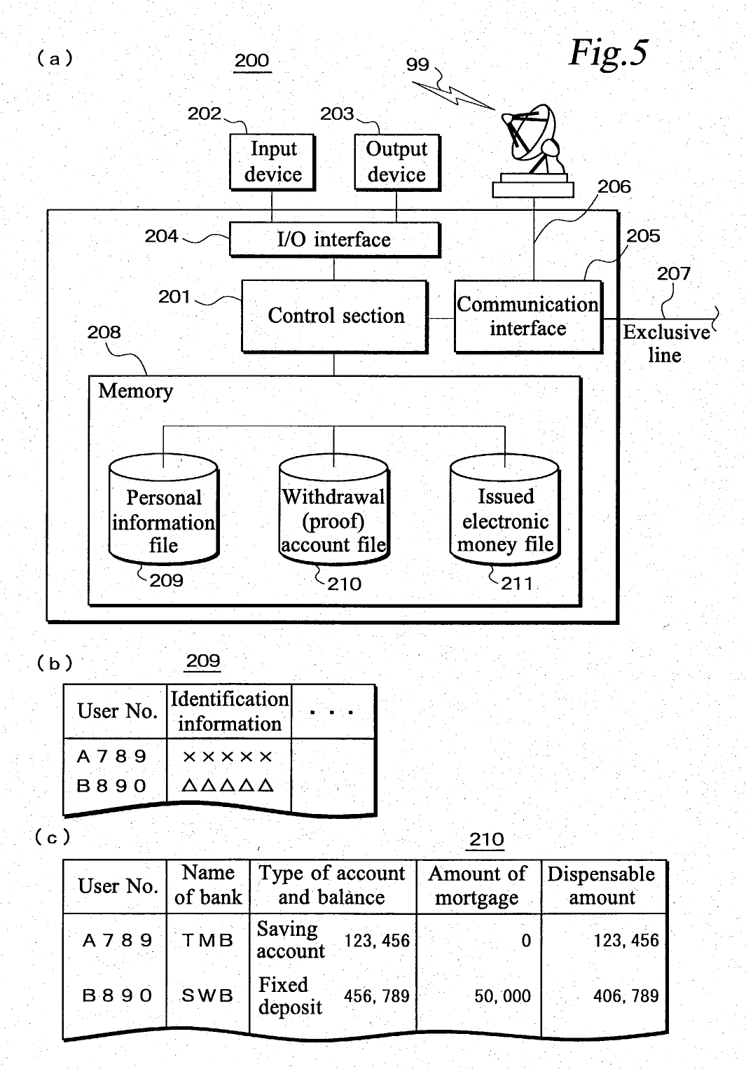

Description will be made of the constitution and operation of the float center server 200 with reference to FIG. 5.

FIG. 5(a) is a block diagram illustrating an example of the constitution of the float center server 200 connected to the user terminals 100 trough the net 99.

The float center server 200 can be implemented in the form of various types of computers such as a personal computer, workstation, and mainframe. The main body 200 of the apparatus has a control section 201 for controlling the entire float center server 200. An input device 202 for inputting information to operate the main body 200 of the apparatus, an output device 203 for outputting results of processes in the main body 200 are connected to the main body 200. The input device 202 and the output device 203 are connected to the control section 201 through an I/O interface 204. The I/O interface 204 controls the input device (such as a keyboard) 202 and the output device (such as a display) 203. The input device 202 and the output device 203, which are illustrated in FIG. 5 as being external devices, may be built in the main body 200.

A communication interface 205 is connected to the control section 201. The control section 201 is connected to the user terminals 100 through the communication interface 205 and the net 99, and transmits and receives information for the issue of electronic money.

The branch computers 300 in which values of proofs of electronic money are stored are connected to the communication interface 205 by exclusive lines 207, and a reservation is made for the proofs corresponding to the amount of electronic money to be issued when the electronic money is issued.

In the main body 200 of the apparatus, a memory 208 for storing information and data necessary for issue and settlement of electronic money is connected to the control section 201. In the memory 208, a personal information file 209, a withdrawal (proof) accounts file 210 and an issued electronic money file 211 are stored. The component files stored in the memory 208 are not limited to the above files.

In this embodiment, personal information data of the users having a structure as shown in FIG. 5(b) and including user numbers and personal identification information are stored in the personal information file 209. The data to be stored may include the other information to be linked with the users (name of banks which the users use, for example). The user number is a number provided to the user at the time of opening of an account for issuing electronic money. The personal identification information is a password or biological information of each user such as fingerprint data, or a combination of both.

In the withdrawal account file 210, withdrawal accounts used as proofs for which a transfer reservation can be made in issuing electronic money and the balances thereof are recorded. As shown in FIG. 5(c), the user number, name of bank, type of deposit and balance, amount of mortgage and dispensable amount are recorded corresponding to each other in the withdrawal account file 210.

The name of bank is the name of a bank in which the withdrawal account exists. The type of deposit here is either a saving account or a fixed deposit, and the balance is the balance of the deposit. The amount of mortgage is an amount set as a mortgage when the user got a loan, for example. The dispensable amount is an amount which can be withdrawn from the account in cash, which is calculated by subtracting the amount of mortgage from the balance of the deposit.

In the issued electronic money file 211, an account necessary to use electronic money is stored. The account may be hereinafter referred to as “float account.” Issued or received electronic money is stored in the float account. In the float account, entry items on electronic money such as the issue number, date of issue, issued amount, settlement date, and term rate, as shown for example in FIG. 13, are stored. The items stored in the issued electronic money file 211 are not limited to the above items.

As the float center server 200, hardwares having a larger capacity than the user terminals 100 have are generally used but the same type of hardware as the user terminals 100 may be used. In this case, server software is installed in the float center server 200 and user software is installed in the user terminals 100.

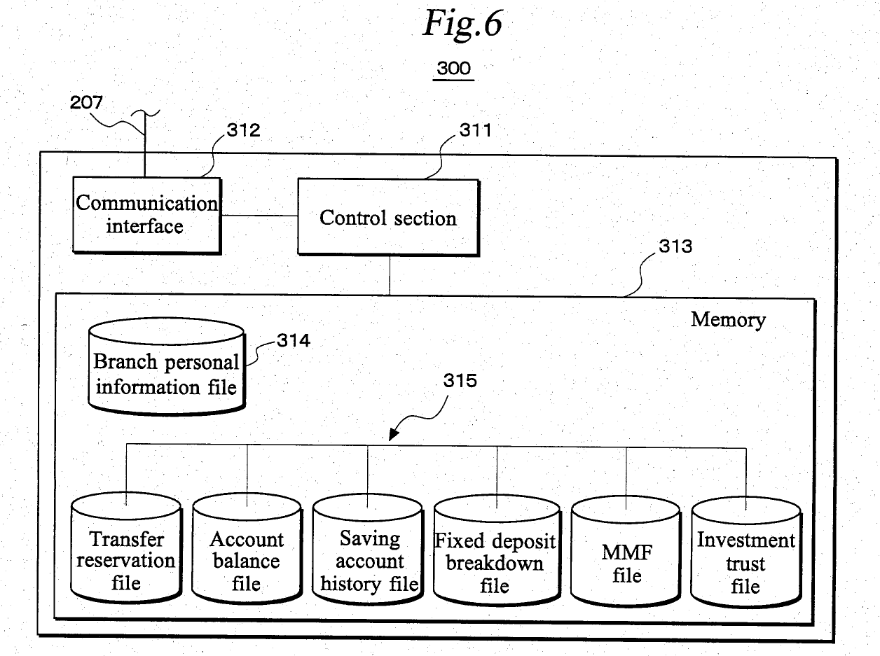

FIG. 6 is a block diagram illustrating an example of the constitution of a branch computer 300, which is connected to the float center server 200 through an exclusive line 207 and in which values of proofs of electronic money are stored. The float center server 200 makes a reservation for the values of proofs of electronic money stored in the branch computer.

“Making a reservation for proofs” herein means to lock the proofs. When a proof is locked, the owner of the proof cannot freely dispose the locked proof until it is unlocked.

The proofs are financial assets such as saving accounts, fixed deposits and credit-limits. The proofs may be ones set by the other float centers or the received electronic money. The credit-limits are set by issuers on mortgage of real estates or securities.

The branch computer 300 has a control section 311. A communication interface 312 is connected to the control section 311, and the control section 311 accepts a reservation for proofs corresponding to the amount of electronic money to be issued to an account from the float center server 200 through the exclusive line 207.

In the branch computer 300, a memory 313 for storing information and data necessary for reservations for electronic money is connected to the control section 311. In the memory 313 is included a branch personal information file 314. Also in the memory 313 are stored a transfer reservation file, an account balance file, a saving account history file, a fixed deposit breakdown file, an MMF file and an investment trust file, which are as proof value files 315, and linked with the branch personal information file 314. In the branch personal information file 314, personal information such as account numbers of users, user passwords (personal identification information), and names of users are stored. The component files in the memory 313 are not limited to the above files.

In the transfer reservation file, reception dates of transfer reservations, transfer dates, transfer destinations, and amounts are recorded. The transfer reservation file is linked with the account balance file, and the sum of amounts reserved to be transferred is recorded in the account balance file. In the account balance file are recorded the balance and dispensable amount in a saving accounts, the amount in a comprehensive fixed deposit accounts, the amount reserved to be transferred into a passbook fixed deposit account, the unresourced amount that is the amount of mortgages, and the sum of amounts reserved to be transferred are recorded.

The dispensable amount is calculated by subtracting the unresourced amount and the amount reserved to be transferred from the total of the balance in the saving account and 90% of the sum of the amount in the comprehensive fixed deposit and 90% of the amount reserved to be transferred into the passbook fixed deposit account, which are recorded in the fixed deposit breakdown file. Thereby, the amount which has been reserved to be transferred cannot be withdrawn from the saving account.

The transaction history of the saving account including deposits, withdrawals and transfers is recorded in the saving account transaction history file, and the file is used when the user has transactions recorded in a passbook. In the MMF file and the investment trust file, the amounts invested in stocks and so on are recorded. The invested amounts can be objects of reservations as proofs.

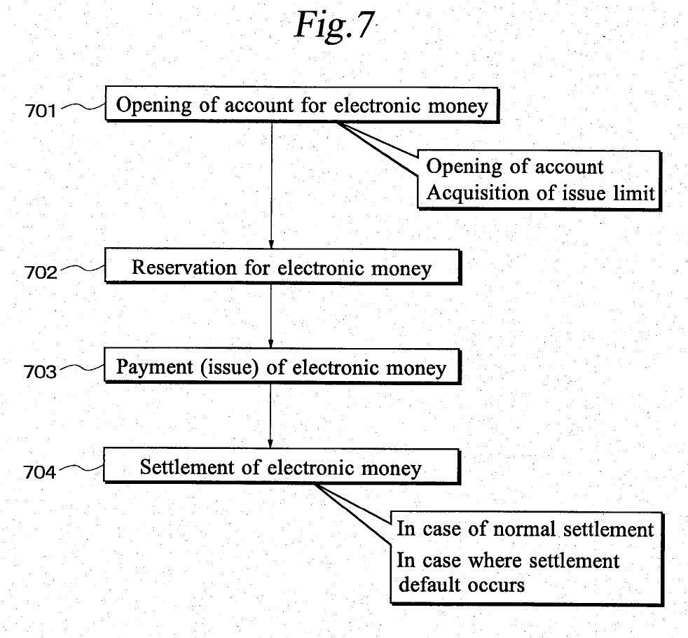

FIG. 7 is a flowchart illustrating the outline of the procedure from acquisition to settlement of electronic money. As shown in FIG. 7, the use of electronic money starts with opening of an account for issuing electronic money. At this time, the user makes a request to the float center to open an account and acquires an issue limit of electronic money.

Then, when the user makes a payment for a purchase transaction by electronic money, the user makes a reservation 702 for electric money worth the amount to be paid. By the reservation, the electronic money is issued and the payment 703 is made by the issued electronic money, whereby the transaction is established.

Finally, when the settlement 704 of the electronic money is made, the electronic money disappears. When a settlement default occurs, the settlement manner is different from the normal way.

The above procedure of the use of electronic money is an outline and a detailed description will be made later.

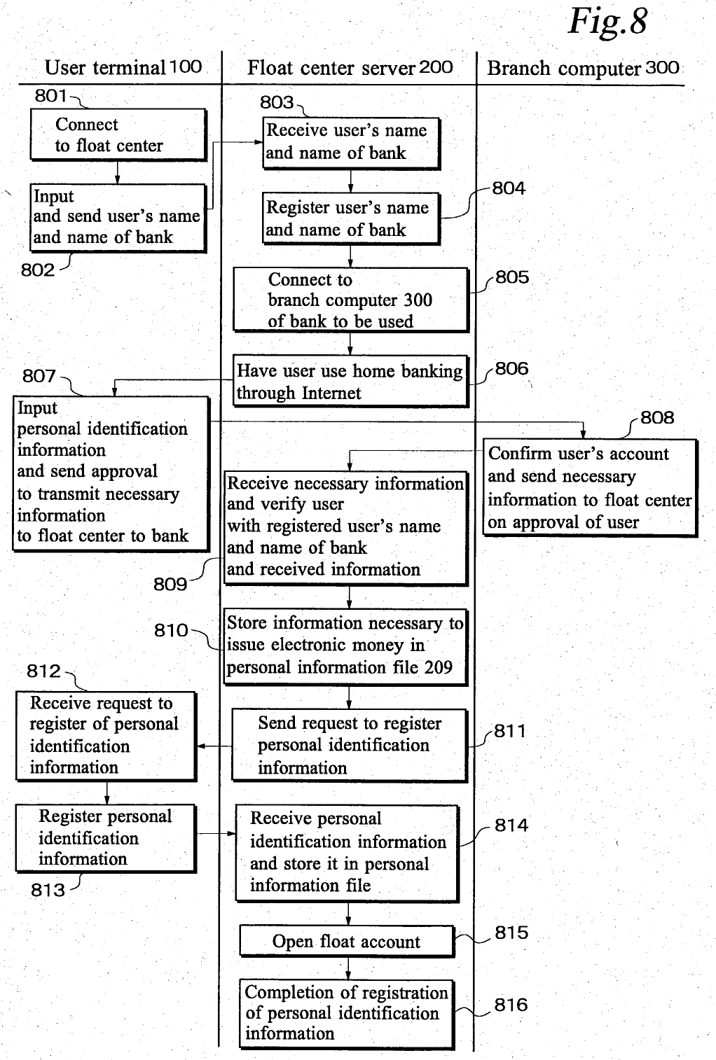

FIG. 8 is a flowchart illustrating an example of the process of registration of personal information which is made when a user uses the float system for the first time. To use the float system, when the user uses the float system for the first time, the user must register its personal information and opens an account for issuing electronic money. First, the user connects the user terminal 100 to the float center server 200 through the network 99 (FIG. 1) (Step 801).

The user inputs its own name and the name of a bank having a branch computer 301 which the user is going to use for settlement of electronic money into the user terminal 100 to forward them to the float center server 200 (Step 802).

The float center server 200 receives the name of the user and the name of the bank (Step 803), and assigns a user number to the user and registers them in the personal information file 209 (Step 804). Also, the float center server 200 connects the branch computer 300 of the bank (step 805) and the user terminal 100 to allow the user to use a home banking system through the internet (Step 806).

The user inputs its personal identification information which has been registered in advance in the branch computer 300 of the bank through the home banking system and sends an approval to transmit information necessary to issue electronic money to the float center (Step 807).

The branch computer 300 receives the approval and confirms the user's account, and then transmits the information necessary to issue electronic money to the float center server 200 on the user's approval (Step 808). At this time, the personal identification information which the user has sent to the bank is not recorded in the float center server 200.

The flat center server 200 can verify the name of the user and the name of the bank registered in Step 804 by receiving the information necessary to issue electronic money from the branch computer 300 (Step 809), and stores the information in the personal information file 209 (Step 810).

Then, the float center server 200 sends a request to register personal identification information necessary to issue or use electronic money to the user terminal 100 (Step 811). The user terminal 100 receives the request (Step 812), and the user sends the personal identification information to verify the user, such as a fingerprint inputted with a fingerprint recognition system 113 included in the user terminal 100, to the float center server 200 (Step 813).

The float center server 200 receives the personal identification information from the user terminal 100 and stores it in the personal information file 209 (Step 814). At the same time, the float center server 200 opens a float account necessary for payment and settlement of electronic money in the user's name (Step 815). Thereby, the registration of the personal information is completed (Step 816).

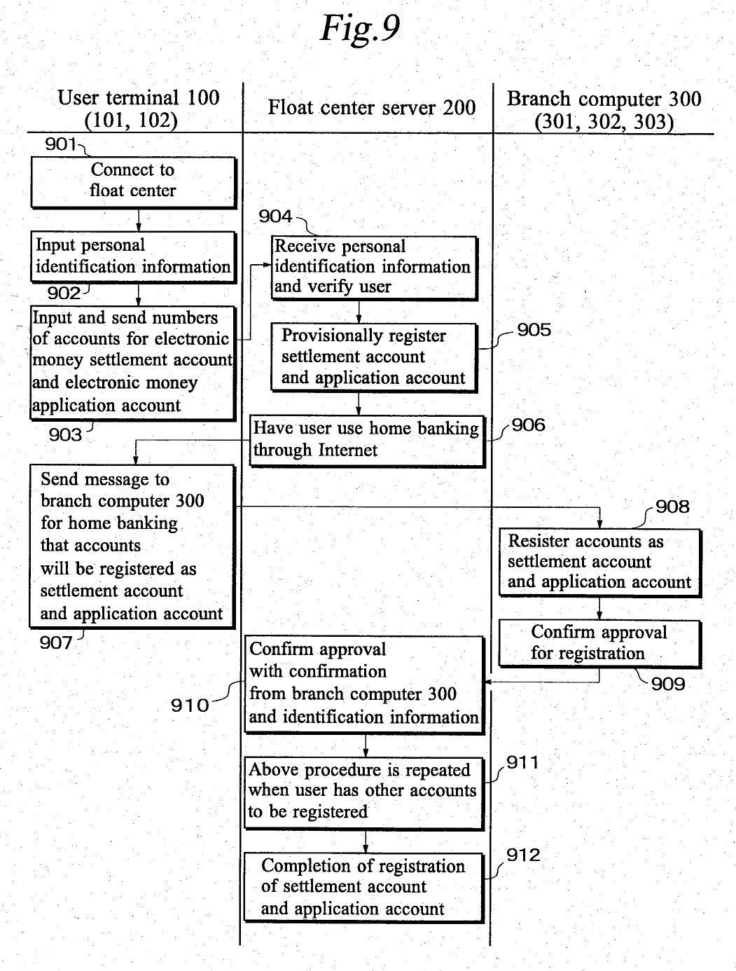

With reference to the flow chart of FIG. 9, next an example of the process of designating an electronic money settlement account and an electronic money application (transfer reservation) account will be described.

First, the user connects the user terminal 100 to the float server center 200 (Step 901). At this time, the user can call the URL address of the float center from the URL address file 118a (FIG. 4) in the memory 118 of the user terminal 100 and use it for the connection. Then, the user inputs its fingerprint information as the personal identification information with the fingerprint recognition system 113 (FIG. 4) (Step 902) and the account number for an electronic money settlement account and the account number for an electronic money application account with keys of the user terminal 100 and transmits them to the float center server 200 (Step 903).

The float center server 200 calls the user's personal identification information stored in the personal information file 209 (FIG. 5) and compares it with the received personal identification information to verify the user (Step 904). The float center server 200 provisionally registers the received account numbers for an electronic money settlement account and for an electronic money application account (Step 905), and then allows the user to use a home banking system through the internet (Step 906).

Using the home banking system by internet, the user inputs the personal identification information registered in advance in the branch computer 300 of the bank and sends the message to the bank that the accounts will be registered as the user's electronic money settlement account and electronic money application account (Step 907).

Of the branch computers 300, a settlement branch computer 301 and an issued amount guarantee branch computer 302 register their accounts as an electronic money settlement account and an electronic money application account, respectively, (Step 908) and send the message that approval for registration has been confirmed to the float center server 200 (Step 909). At this time, the personal identification information the user has sent to the bank is not recorded in the float center server 200.

The float center server 200 confirms the approval of the user with the confirmation of approval for registration received from the branch computer 300 and the personal identification information received in Step 904 (Step 910). The above procedure is repeated when the user has the other accounts to be registered (Step 911). It is registered in the branch personal information file 314 in the branch computer 300 that their accounts are an electronic money settlement account and an electronic money application account (FIG. 6).

Then, the float center server 200 registers the account number of the thus registered electronic money settlement account or the electronic money application account in the withdrawal account file 210 (FIG. 5).

Then, the registration of electronic money settlement account and electronic money application account in the float center server 200 is completed (Step 912).

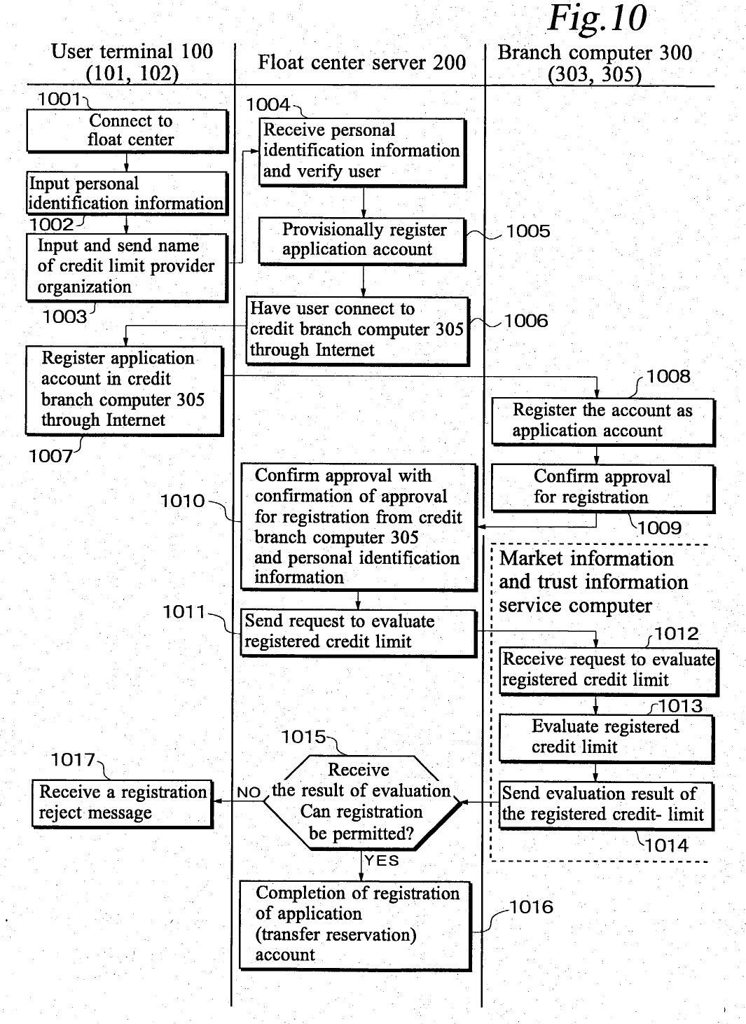

With reference to the flow chart of FIG. 10, an example of the process of designating an electronic money settlement account and an electronic money application account (an account as an object of reservation) by designating a credit-limit will be described next.

First of all, the user connects the user terminal 100 to the float center server 200 (Step 1001). Then, the user inputs its personal identification information (Step 1002) and the name of a credit-limit provider and send them to the float center server 200 (Step 1003).

The float center server 200 verifies the user by the received personal identification information (Step 1004). After provisionally registering an electronic money application account (Step 1005), the float center server 200 has the user connect to a credit branch computer 305 of the credit-limit provider through the internet (Step 1006).

The user sends the message to the credit-limit provider that it will register an electronic money application account to the credit branch computer 305 thereof through the Internet (Step 1007).

The credit branch computer 305 receives the message and registers that their account is the electronic money application account (Step 1008), and then sends the message that approval for registration has been confirmed, to the float center server 200 (Step 1009).

The float center server 200 confirms the approval of the user with the confirmation of approval for registration received from the credit branch computer 305 and the personal identification information received in Step 1004 (Step 1010).

The float center server computer 200 then sends a request to a market information and credit information service computer of a market information and credit information provider (FIG. 3) as a credit branch computer 305 to evaluate the registered credit limit (Step 1011).

The market information and credit information service computer receives the request (Step 1012), evaluates the credit-limit (Step 1013) and sends the evaluation result to the float center server 200 (Step 1014).

The float center server 200 receives the result of evaluation of the registered credit limit and judges whether the registration can be permitted or not (Step 1015). When the registration can be permitted (YES in Step 1015), the registration of a credit limit application account in the float center server 200 is completed (Step 1016).

When the registration can not be permitted (NO in Step 1015), the float center server 200 sends a registration reject message to the user terminal 100 and the user confirms the rejection of registration (Step 1017).

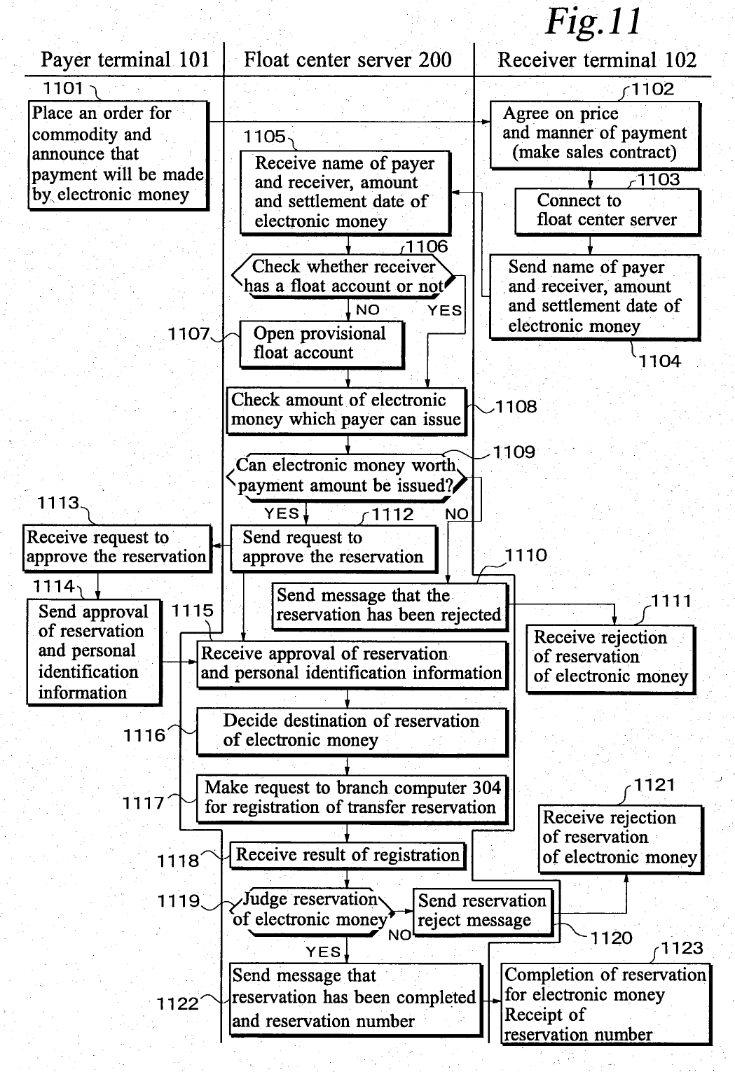

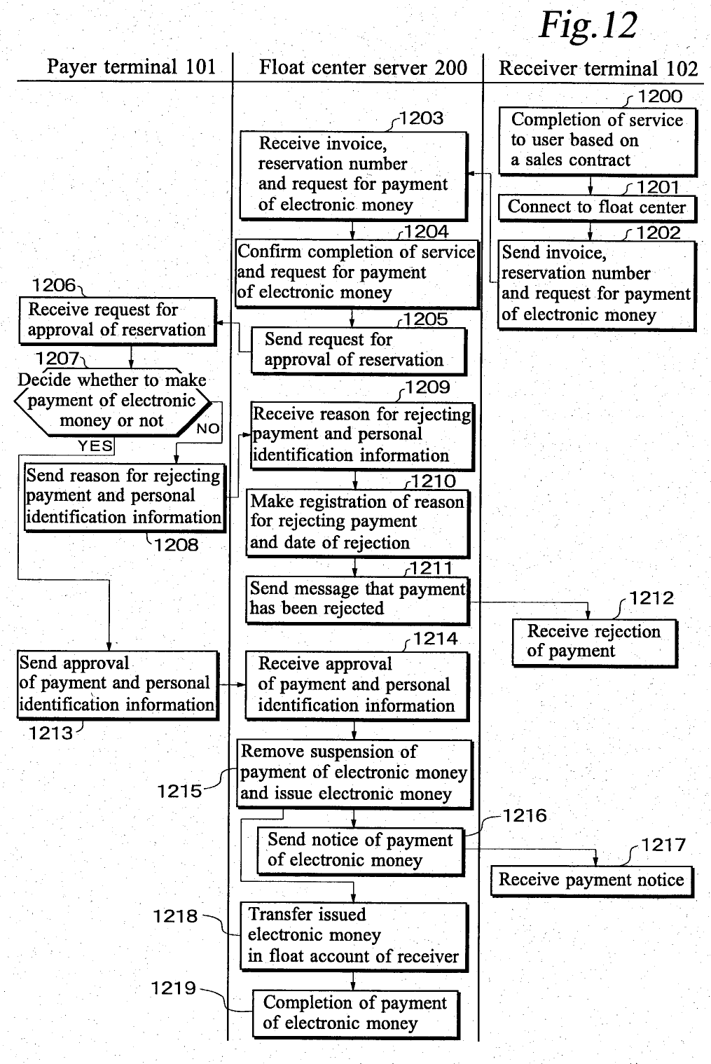

With reference to the flowcharts shown in FIG. 11 and FIG. 12, the process of a user paying for a purchase transaction by electronic money will be described next. In order to issue electronic money worth the amount to be paid, it is necessary to make a reservation for electronic money.

FIG. 11 is a flowchart showing an example of the process of a user making a reservation for electronic money.

First, a user as a payer of electronic money (which may be hereinafter referred to as “payer”) places an order for a commodity to a receiver of electronic money (which may be hereinafter referred to as “receiver”) and announces that the payment will be made by electronic money. A sales contract is made between the payer and the receiver when they reach agreement on the price and the manner of payment.

The receiver connects the receiver terminal 102 with the float center server 200 (Step 1103), and sends the names of the payer and receiver, the amount and, settlement date of electronic money based on the sales contract to the float center server 200 (Step 1104).

The float center server 200 receives the names of the payer and receiver, the amount, and settlement date of electronic money from the receiver terminal 102 and registers them (Step 1105). Then, the float center server 200 checks whether the receiver has made a registration of a float account or not (Step 1106). When the receiver has not made a registration of a float account (NO in Step 1106), the float center server 200 opens a provisional float account (Step 1107).

The float center server 200 then checks the amount of electronic money which the payer can issue (Step 1108), and judges whether electronic money worth the amount to be paid or electronic money to be issued (which may be hereinafter referred to as “issue amount”) can be issued or not (Step 1109). When the electronic money cannot be issued due to insufficient fund or violation of a requirement (NO in Step 1109), the float center server 200 sends the message that the reservation of electronic money has been rejected to the user terminal 102 (Step 1110). With the receipt of the message by the receiver terminal 102 (Step 1111), the receiver confirms the rejection of reservation of electronic money.

When electronic money worth the payment amount can be issued (YES in Step 1109), the float center server 200 sends a request to approve a reservation of the electronic money to the payer terminal 101 (Step 1112).

When the payer terminal 101 receives the request to approve the reservation of the electronic money (Step 1113), and when the payer approves a reservation of the electronic money, the payer sends approval of the reservation and its personal identification information to the float center server 200 (Step 1114). Steps 1113 and 1114 may be performed using the receiver terminal 102, or Steps 1103 and 1104 may be performed using the payer terminal 101.

Namely, in a purchase transaction, at least either of the payer terminal 101 and receiver terminal 102 is enough.

The float center server 200 receives the approval of the reservation of the electronic money and the personal identification information from the payer terminal 101 (Step 1115), and decides the destination of the reservation of the electronic money among registered application accounts (Step 1116). Then, the float center server 200 makes an access to a transfer reservation branch computer 304 of the thus decided destination of the reservation and makes a request to make a registration of a transfer reservation for the issue amount to the application account (Step 1117). The transfer reservation here may be hereinafter referred to simply as “reservation.”

The transfer reservation branch computer 304 receives the request and makes a registration of the transfer reservation to the application account, and then sends the result of the registration to the float center server 200.

The float center server 200 receives the result of the registration from the transfer reservation branch computer 304 (Step 1118) and judges the reservation of the electronic money based on the result of the registration (Step 1119). When the registration of reservation cannot be made (NO in Step 1119), the float center server 200 sends a reservation reject message to the receiver terminal 102 (Step 1120). With the receipt of the message by the receiver terminal 102 (Step 1121), the receiver confirms that the reservation of the electronic money has been rejected.

When the registration of reservation can be made (YES in Step 1119), the reservation of the electronic money is completed. The float center server 200 sends the message that the reservation has been completed and a reservation number to the receiver terminal 102 (Step 1122). With the receipt of the message and the reservation number with the receiver terminal 102, the receiver confirms the completion of the reservation and the reservation number.

In general, the completion of reservation of electronic money means that the electronic money has been issued to the receiver by the payer. The payment of the electronic money is made simultaneously with the issue thereof.

However, in some cases, the payer wishes to suspend the payment of electronic money to the receiver even when the reservation thereof has been completed. For example, it is when the payer places an order by mail order or when the payer suspends the payment until it confirms that the service will have been provided as contracted.

With reference to a flow chart of FIG. 12, an example of the process at the time when a user suspends a payment of electronic money of a payment amount will be described next.

First, an electronic money receiver provides a service to an electronic money payer based on a sales contract. When the service is completed, the receiver sends an invoice, a reservation number and a request for payment of electronic money to the float center server 200 using the receiver terminal 102 (Step 1202).

The float center server 200 receives the invoice, the reservation number and the request for payment of electronic money from the receiver terminal 102 (Step 1203). After confirmation of completion of the service and the request for the payment (Step 1204), the float center server 200 sends the request for payment of electronic money to the payer terminal 101 (Step 1205).

With the receipt of the request for payment of electronic money by the payer terminal 101, the payer confirms the request for payment of electronic money (Step 1206) and decides whether to make the payment of the electronic money or not (Step 1207).

When the payer rejects the payment (NO in Step 1207), the payer sends the reason for rejecting the payment and its personal identification information to the float center server 200 using the payer terminal 101 (Step 1208).

When the float center server 200 receives the reason for rejecting the payment and the personal identification information (Step 1209), the float center server 200 makes a registration of the reason for rejecting the payment and the date of the rejection (Step 1210) and sends the message that the payment has been rejected to the receiver terminal 102 (Step 1211).

With the receipt of the message by the receiver terminal 102 (Step 1212), the receiver confirms that the payment has been rejected.

When the payer approves the payment (YES in Step 1207), the payer sends the approval of the payment and its personal identification information to the float center server 200 using the payer terminal 101 (Step 1213).

When the float center server 200 receives the approval of the payment and the personal identification information (Step 1214), the float center server 200 removes the suspension of payment of the electronic money and issues the electronic money (Step 1215). Then, the float center server 200 sends a notice of payment of the electronic money to the receiver terminal 102. With the receipt of the payment notice by the receiver terminal 102 (Step 1217), the receiver confirms the payment of the electronic money.

At the same time, the flat center server 200 stores the issued electronic money in the float account of the receiver in the issued electronic money file 211 (FIG. 5) (Step 1218), thereby completing the payment of the electronic money (Step 1219).

The issuer of electronic money may be a company or a self-governing body. In this case, the personal identification information can be that of a representative of the company or the self-governing body, or a person (or persons) entrusted with issuing electronic money by the representative. Also, the proof is typically a property of the self-governing body but may be the credit of the self-governing body.

The self-governing body herein may be a nation such as Japan or a local government such as Tokyo Metropolitan Government. For example, Bank of Japan as a representative of Japan sets a specific amount based on the credit of Japan according to the economic policy thereof, and issues electronic money within the specific amount. Electronic money issued by an individual is generally allowed to be exchanged with electronic money issued by Bank of Japan. At this time, the proof is electronic money issued by Bank of Japan or Bank of Japan notes. The exchange rate between electronic money issued by for example Tokyo Metropolitan Government and electronic money issued by Bank of Japan may vary.

The entry items on issued electronic money are shown in FIG. 13. Such a data structure is stored in the issued electronic money file 118b (FIG. 4) in the user terminal 100. On electronic money, an issue number 1301, date of issue 1302, date of settlement 1303, the amount 1304 and a term rate 1305 are written. Information that electronic money has is not limited to the above. The other information is stored in the issued electronic money file 211 (FIG. 5) in the float center server 200. The entry items on electronic money and the other information are linked with each other via the issue number.

The entry items on electronic money in the issued electronic money file 118b are occasionally updated based on data in the float center server 200. “Occasionally” herein means that the update may be made by an operation of a terminal user on its own volition or automatically, for example, every time the user terminal 100 is activated.

The term rate, which is a rate corresponding to the short-term prime rate or long-term prime rate at the moment or an appropriate rate determined by the float center, is used to calculate the value of the amount to be settled at the time of the settlement.

The issuable amount is an amount which can be reserved as electronic money based on proofs and calculated by multiplying a specified reduction rate by the original values of the proofs. The reduction rate is, for example, 1.0 or less.

When a payment for a purchase transaction is made with issued electronic money, the settlement must be made on the settlement day set at the reservation of the electronic money.

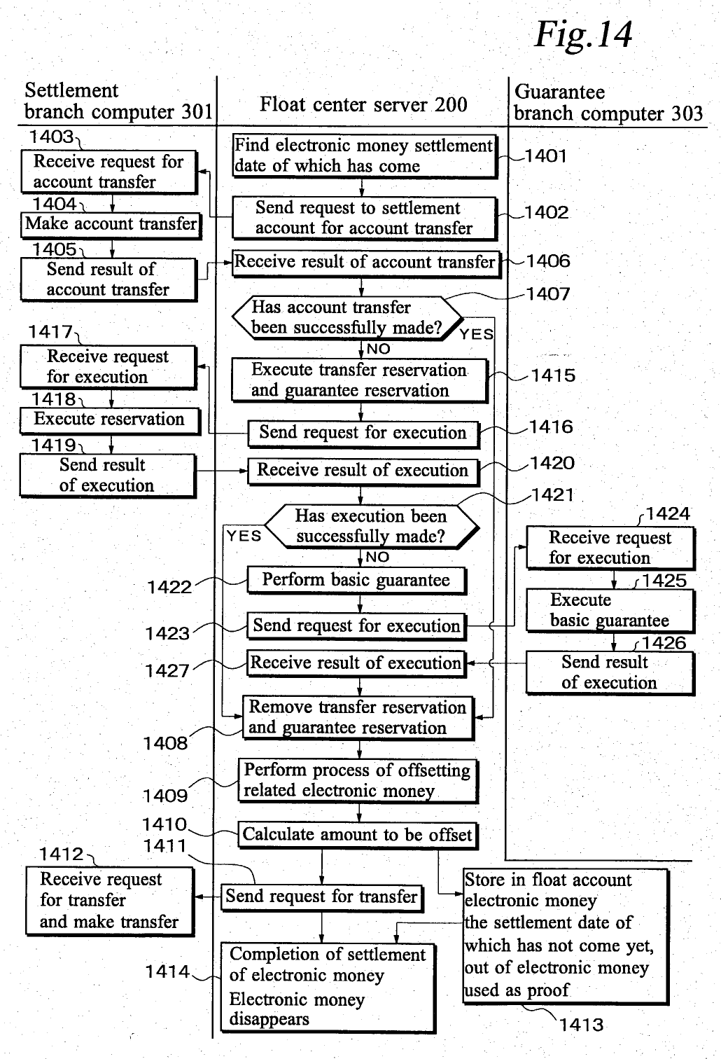

FIG. 14 is a flowchart showing an example of the process at the time when a user makes a settlement of electronic money.

The float center server 200, finds the electronic money the settlement date of which has come (Step 1401) and sends a request for an account transfer for the settlement account to a settlement branch computer 301 having the settlement account (Step 1402).

The settlement branch computer 301 having the settlement account receives the request (Step 1403), and makes the account transfer (Step 1404) and sends the result of the account transfer to the float center server 200 (Step 1405).

The float center server 200 receives the result of the transfer (Step 1406), and judges whether the transfer has been successfully made or not (Step 1407).

When the float center server 200 judges that the transfer has been successfully made (YES in Step 1407), the float center server 200 removes the reservation or guarantee reservation (Step 1408) and performs a process of offsetting related electronic money in the float account of the user (Step 1409) to calculate the amount to be offset (Step 1410). The guarantee reservation herein is a reservation or a lock for something to guarantee the proof for a reserved amount of electronic money in making a reservation thereof (such as a credit limit or a real estate).

When the calculation of the amount to be offset is completed, the float center server 200 sends a request for a transfer of the amount to be offset to the settlement branch computer 301 having the settlement account (Step 1411). The settlement branch computer 301 having the settlement account receives the request and makes the transfer (Step 1412). When electronic money has been issued using received electronic money as a proof, the electronic money used as the proof the settlement date of which has not come yet is stored in the float account in the issued electronic money file 211 (Step 1413).

Thereby, the settlement of the electronic money is completed (Step 1414), and the electronic money disappears.

When the account transfer has not been successfully made (NO in Step 1407), the float center server 200 will execute a reservation or a guarantee reservation (Step 1415), and sends a request for execution of a reservation or a guarantee reservation to a credit branch computer 302 of a bank or a credit-limit provider (Step 1416).

The credit branch computer 302 receives the request (Step 1417), executes the reservation or the guarantee reservation (Step 1418), and sends the result of the execution to the float center server 200 (Step 1419).

The float center server 200 receives the result of the execution (Step 1420), and judges whether the execution has been successfully made or not (Step 1421). When the execution has been successfully made (YES in Step 1421), the float center server 200 removes the transfer reservation and guarantee reservation (Step 1408). The process thereafter is the same as that in the case where the server computer 200 judges that the transfer has been successfully made.

When the execution has failed (NO in Step 1421), the float server computer 200 performs a basic guarantee (Step 1422), and sends a request for execution of a basic guarantee to a basic guarantee branch computer 303 in a guarantee company center (Step 1423).

The basic guarantee branch computer 303 receives the request (Step 1424), executes the basic guarantee (Step 1425), and sends the result of the execution (Step 1426).

The float center server 200 receives the result of the execution (Step 1427), and removes the transfer reservation and guarantee reservation (Step 1408).

The process thereafter is the same as that in the case where the server computer 200 judges that the transfer has been successfully made.

The above embodiment is the process from acquisition to settlement of electronic money. However, as mentioned before, the above embodiment is merely an example and the present invention is not limited thereto.

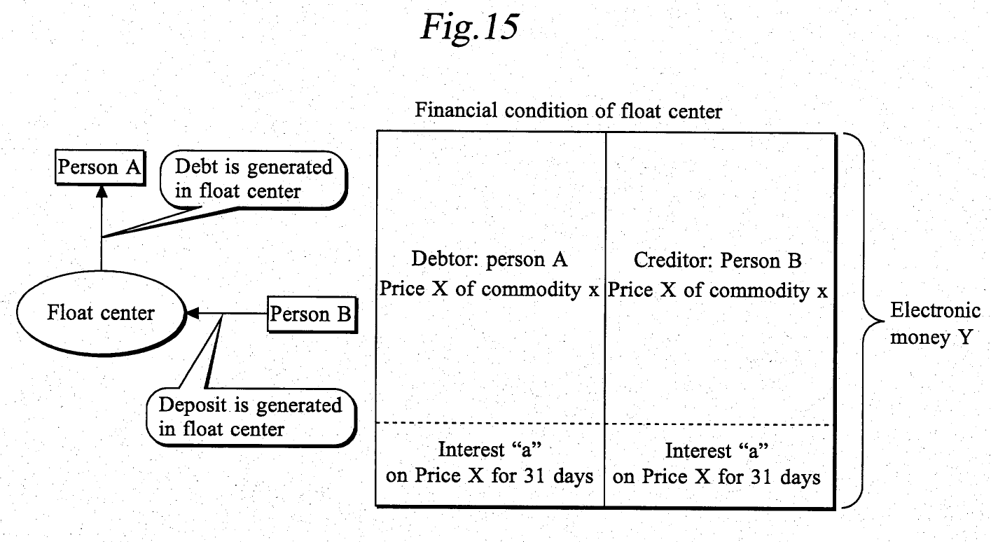

With reference to a conceptual diagram in FIG. 15, description will be made of how electronic money is used in a real commercial transaction using a concept of debt and credit in specific examples.

FIG. 15 is a conceptual view of Transaction Example 1, for explaining a transaction between a person A as a payer of electronic money and a person B as a receiver thereof.

When the person A purchases a commodity x for a price X from the person B on July 1st, the person A pays the price X by electronic money of a settlement day, August 1st. In this case, the person A owes a debt to the float center and the person B gets a deposit in the float center.

In the financial condition of the float center, the persons A and B are a debtor and a creditor, respectively, for the price X. At this time, interest “a” for the 31 days from the issue date of the electronic money, July 1st, to the settlement date thereof, August 1st, is generated. Thus, the amount Y of electronic money to be paid to the person B is a total of the price X and the interest “a”. The interest “a” is calculated as follows:

Interest “a”=Price X×Term rate Σ×Deferment period (31 days)/365

wherein 365 is the number of days in a year to calculate interest on a daily basis.

The electronic money Y to be paid to the person B is as follows:

Electronic money Y=Price X+Interest “a”

The person A makes a settlement of the electronic money Y paid to person B to the float center on the settlement day, August 1st, and the person B can exchange the deposit in the float center (electronic money) for cash at any time on and after the settlement date, August 1st.

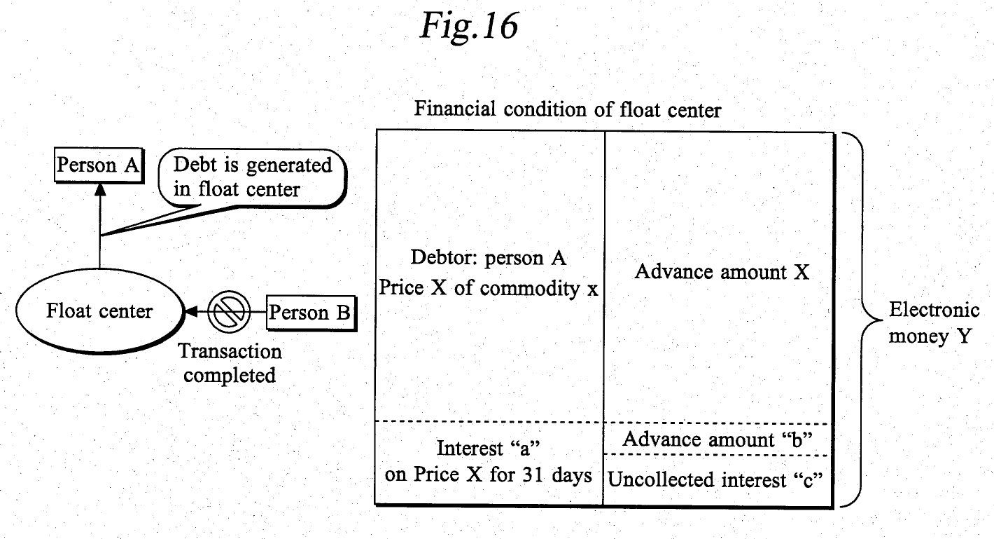

Description will be next made of Transaction Example 2, in which the person B exchanges the electronic money received in the above commercial transaction for cash before the settlement date thereof, August 1st, with reference to a conceptual view in FIG. 16.

As shown in FIG. 16, the person A owes a debt to the float center and the settlement day thereof will not be changed depending upon the action of the person B. The person B has not get a right to a part of the interest “a” in the received electronic money Y at the moment, and the person B can receive, in cash, only the amount corresponding to the price X and interest for the period which has already passed.

Suppose that the person B exchanges the electronic money received from the person A for cash on July 10th.

In the financial condition of the float center, the person A is a debtor for the price X, and interest “a” for 31 days from the issue day of the electronic money, July 1st, to the settlement day thereof, August 1st, is generated.

The credit and debit of the person B consists of an advance amount X for the price X, an advance amount “b” for the interest for the ten days from July 1st to July 10th which have already passed at the moment, and uncollected interest “c”, which is interest “c” for the 21 days from July 10th to August 1st which have not passed yet.

Thus, the advance amount “b” and the uncollected interest “c” are calculated as follows:

Interest “a” for the amount X for 31 days=Interest “b” for the period which has already passed +Interest “c” for the period which has not passed yet

Advance amount “b”=Interest “b” for the period which has already passed=Price X×Term rate Σ×Deferment period (10 days)/365

Uncollected interest “c”=Interest “c” for the period which has not passed yet=Price X×Term rate Σ×Deferment period (21 days)/365

Therefore, the amount X′ which the person B can receive in cash on July 10th is as follows:

Amount X′ receivable in cash=Advance amount X+Advance amount “b”

The uncollected interest “c” is given to the float center.

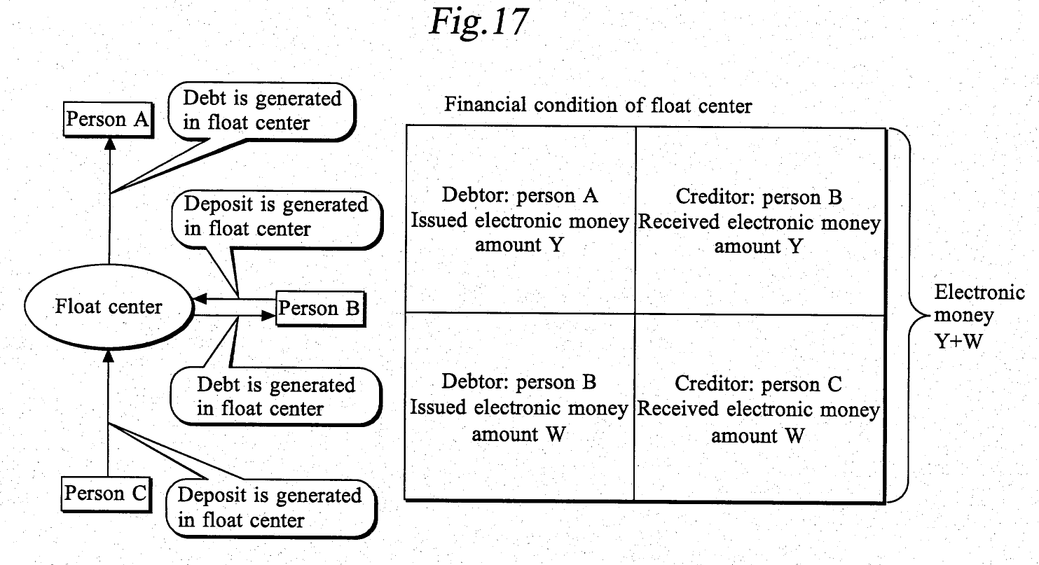

With reference to a conceptual view in FIG. 17, description will be next made of Transaction Example 3, in which a person A makes a payment of a price X for a commodity x to a person B by electronic money Y with a settlement date of August 1st on July 1st, and the person B makes a payment of a price V for a commodity v to a person C by electronic money issued using the electronic money Y received from the person A as a proof.

As shown in FIG. 17, the person A owes a debt to the float center, the person B has a deposit in the float center and owes a debt thereto, and the person C has a deposit in the float center.

The issue date and the settlement date of the electronic money issued by the person B is July 15th and July 20th, respectively, so that interest “d” for the 5 days from the issue date, July 15th, to the settlement date, July 20th is generated. Thus, the nominal amount of electronic money to be paid to the person C is a total amount W of the price V and the interest “d”. The interest “d” is calculated as follows:

Interest “d”=Price V×Term rate Σ×Deferment period (5days)/365

Thus, the amount W is as follows:

Amount W=Price X+Interest “d”

In this case, in the financial condition of the float center, the electronic money Y issued by the person A as a debtor and the electronic money W issued by the person B are offset by the electronic money Y received by the person B as a creditor and the electronic money received by the person C.

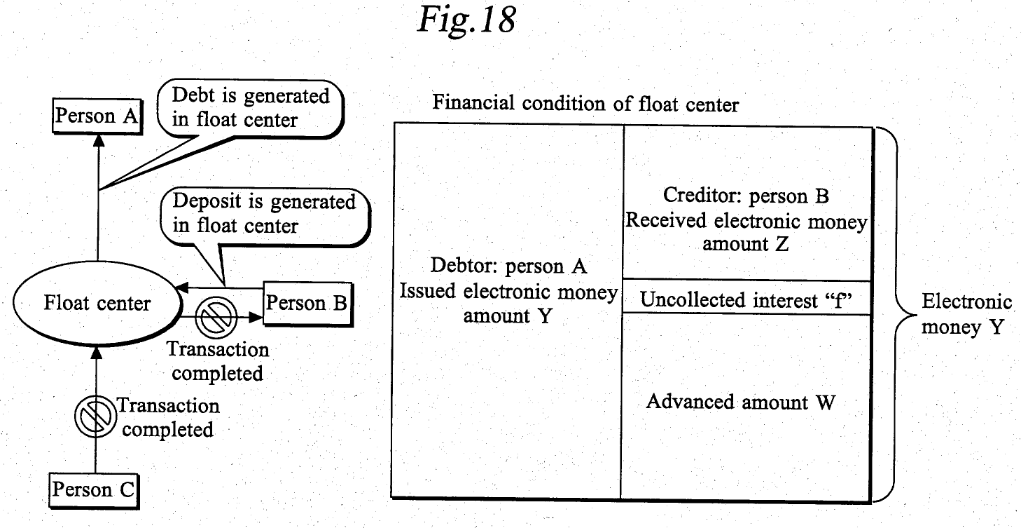

With reference to a conceptual view in FIG. 18, Transaction Example 4, in which the electronic money issued by the person B is settled on July 20th, will be described.

As shown in FIG. 18, the person A owes a debt to the float center, and the settlement date thereof is not changed depending upon the action of the person B. The person B has no debt to the float center but has only a deposit therein, and the person C has completed the transaction with the float center.

The person B must make a settlement of the electronic money W to the float center. In this case, the person B makes a request to the float center to make an advance payment of the electronic money W based on the electronic money received from the person A. This means that the person B receives the amount corresponding to the electronic money W in advance out of the electronic money Y which the person B has received.

In the financial condition of the float center, the person A is a debtor for the electronic money Y and the issued amount of the electronic money Y includes the interest “a” for the 31 days from the issue date of the electronic money, July 1st, to the settlement date thereof, August 1st.

The credit and debit of the person B consists of an advance amount “e” as interest for the 20 days from July 1st to July 20th which has already passed at the moment, uncollected interest “f” as interest “f” for the 11 days from July 20th to August 1st which has not passed yet, an advance amount W for the electronic money W paid to the person C, and an amount Z calculated by subtracting the uncollected interest “f” and the advance amount W from an advance amount Y as a credit for the electronic money Y.

The interest “e” which the person B received and the uncollected interest “f” are calculated as follows:

Interest “a” for the amount X for the 31 days=Interest “e” for the period which has already passed+Interest “f” for the period which has not passed yet

Interest “e” which the person B received=Interest “e” for the period which has already passed=Price X×Term rate Σ×Deferment period (20 days)/365

Uncollected interest “f”=Interest “f” for the period which has not passed yet=Price X×Term rate Σ×Deferment period (11 days)/365

Therefore, the amount of electronic money Z which the person B has as a deposit in the float center on July 20th is as follows:

Electronic money Z=Electronic money Y−Advance amount W−Uncollected interest “f”

Thereby, the settlement of the electronic money W is completed, and the person C can exchange the received electronic money W at any time. The uncollected interest “f” is given to the float center.

As described above, the person B can purchase or sell a commodity only by electronic money electronically circulating without paying or receiving real bills or coins.

Industrial Applicability

As described above, according to the present invention, there is a step of linking issuer identification information with one or more substantial proofs belonging to the issuer to allow a reservation based upon the amount of electronic money to be issued to be made for the substantial proofs. Therefore, guaranteed electronic money can be issued.

1. A method for issuing electronic money, comprising the steps of:
inputting issuer identification information for identifying an issuer with a user terminal;
inputting an amount of electronic money to be issued with said user terminal;
inputting a specific settlement date from said user terminal; and
linking said inputted issuer identification information with one or more substantial proofs belonging to said issuer to allow a reservation based upon said amount of electronic money to be issued to be made for said one of more substantial proofs.

2. A method for issuing electronic money, comprising the steps of:
receiving issuer identification information for identifying an issuer inputted with a user terminal therefrom;
receiving an amount of electronic money to be issued inputted with said user terminal therefrom;
receiving a specific settlement date inputted with said user terminal therefrom; and
linking said received issuer identification information with one or more substantial proofs belonging to said issuer to make a reservation based upon said received amount of electronic money to be issued for said one of more substantial proofs.

3. A method for issuing electronic money, comprising the steps of:
receiving values of one or more proofs belonging to an issuer from a proof managing server for managing said proofs associating said proofs with said issuer;
storing original values of said proofs which are real values of said proofs or substantial values of said proofs which are calculated by multiplying a specified reduction rate by said original values of said proofs in a proof value file;
linking said values of the proofs stored in said proof value file with said proofs managed by proof managing server; and
making a reservation for said proofs within a total substantial proof value which is a sum of said substantial values of said proofs stored in said proof value file and designating a specific settlement date to issue electronic money which is valid until said settlement date.

4. The method for issuing electronic money as recited in any one of claims 1 to 3,
wherein, in making said reservation for said proofs, a proof with lower liquidity is reserved first.

5. The method for issuing electronic money as recited in any one of claims 1 to 4,
wherein said amount of electronic money to be issued is a total of a price of an object of transaction and interest on said price for days from the date of issue of the electronic money to said specific settlement date.

6. Electronic money issued by a method for issuing electronic money as recited in any one of claims 1 to 5.

7. An electronic money issuing server, comprising:
an issuer identification information file for storing issuer identification information for identifying an issuer inputted with an user terminal;
an issue amount file for storing an amount of electronic money to be issued inputted with said user terminal;
a settlement date file for storing a specific settlement date inputted with said user terminal; and
a control section for linking said issuer identification information and one or more substantial proofs belonging to said issuer to make a reservation based upon said inputted amount of electronic money to be issued for said substantial proofs.

8. A user terminal, comprising:
an issuer identifying means for identifying an issuer and generating issuer identification information;
an issue amount input means for inputting an amount of electronic money to be issued;
a settlement date input means for inputting a specific settlement date of said electronic money; and
a transmission means for transmitting said issuer identification information, said amount of electronic money to be issued and said specific settlement date to an electronic money issuing server for making a reservation based upon the amount of electronic money to be issued for substantial proofs while linking the issuer identification information, the amount of electronic money to be issued and the specific settlement date with one or more substantial proofs belonging to the issuer.

9. An electronic money issuing server, comprising:
a receiving means for receiving values of one or more proofs belonging to an issuer from a proof managing server for managing the proofs by associating said proof with said issuer;
a proof value file for storing original values of said proofs which are real values of said proofs or substantial values of said proofs which are calculated by multiplying a specific reduction rate by said original values of said proofs; and
a link control section for linking said values of the proofs stored in said proof value file with said proofs managed by said proof managing server; and
said electronic money issuing server being adapted to make a reservation for said proofs within a total substantial proof value which is a sum of said substantial values of said proofs stored in said proof value file and designating a specific settlement date to issue electronic money which is valid until said settlement date.

10. An electronic money issuing system, comprising:
a host computer for managing electronic money;
a branch computer connected or connectable to the host computer; and
a user terminal connected or connectable to the host computer and used to input issuer identification information and an amount of electronic money to be issued by an issuer when said issuer issues electronic money; and
said branch computer having a proof value file for storing substantial values of one or more substantial proofs belonging to said issuer of electronic money;
the host computer being configured to link said issuer identification information with said proof value file in said branch computer; and
said host computer being adapted to issue electronic money which is valid until a specific settlement day designated based on an input with said user terminal within a total proof value which is a sum of said substantial values of the proofs, and to make a reservation for said proofs in an amount corresponding to said amount of electronic money to be issued inputted with said user terminal when said electronic money is issued.

11. An electronic money issuing server,
connected or connectable to a branch computer having a proof value file for storing substantial values of one or more substantial proofs belonging to an issuer of electronic money;
connected or connectable to a user terminal used to input issuer identification information and an amount of electronic money to be issued by an issuer when said issuer issues electronic money;
adapted to link said issuer identification information transmitted from said user terminal with said proof value file in said branch computer; and
adapted to issue electronic money which is valid until a specific settlement date designated based on an input with said user terminal within a total proof value which is a sum of said substantial values of the proofs, and to make a reservation for said proofs in an amount corresponding to said amount of electronic money to be issued inputted with said user terminal when said electronic money is issued.

12. An electronic money issuing server,
connected or connectable to a branch computer having a proof value file for storing substantial values of one more substantial proofs belonging to an issuer of electronic money;
connected or connectable to a user terminal used to input issuer identification information and an amount of electronic money to be issued by an issuer when said issuer issues electronic money;
having an electronic money scheduled issue amount file for storing the issuer identification information and a scheduled issue amount of electronic money associated with said issuer identification information;
said scheduled issue amount of electronic money in said electronic money scheduled issue amount file being linked with said substantial values of said proofs in said proof value file in said branch computer;
said electronic money being issued with a specific settlement date designated based on an input with said user terminal within said scheduled issue amount of electronic money in said electronic money scheduled issue amount file as being valid until said settlement date; and
configured to make a reservation for said proofs in an amount corresponding to said amount of electronic money to be issued inputted with said user terminal when said electronic money is issued.

13. A user terminal,
connected or connectable to said electronic money issuing server as recited in claim 11 or 12; and
configured to be used to input issuer identification information for identifying said issuer and an amount of electronic money to be issued when said, issuer issues the electronic money.

14. The user terminal as recited in claim 13,
further comprising a biological information input means for inputting biological information peculiar to an individual; and
configured to use said biological information as said issuer identification information.
